(19) United States
(12) Patent Application Publication
(10) Pub. No.: US 2020/0394399 A1
(43) Pub. Date: Dec. 17, 2020

(54) SYSTEM AND METHOD FOR THE IDENTIFICATION OF OBJECTS

(71) Applicant: Tracera Inc, Palo Alto, CA (US)

(72) Inventors: Seth Lee Gilbert, Palo Alto, CA (US); William Brian Kinard, Palo Alto, CA (US)

(21) Appl. No.: 16/898,823

(22) Filed: Jun. 11, 2020

Related U.S. Application Data
(60) Provisional application No. 62/861,168, filed on Jun. 13, 2019.

(51) Int. Cl. G06K 9/00; G06K 9/62; G06K 9/46; G06T 7/50; G06K 9/20; G06N 20/00; G06K 19/06

(52) U.S. Cl. CPC G06K 9/00577; G06K 9/6202; G06K 9/4661; G06K 9/4652; G06K 2009/0059; G06K 9/2027; G06N 20/00; G06K 19/06037; G06T 7/50

(57) ABSTRACT

The present design describes devices, systems and methods for identifying, authenticating and tracing items. Unique, inexpensive tags are attached to typical items, which makes the item itself unique. Then, ubiquitous, inexpensive and easy-to-use imaging devices capture the tag and then identify, authenticate or trace the tag and item using image processors or other appropriate devices. In another embodiment, the unique tag and item are traced from origin to destination using image capture and image processing devices relying on information about tags provided in a database.

The present application claims priority based on U.S. Provisional Patent Application Ser. No. 62/861,168, entitled “Devices, Systems, and Methods for Identification of Objects,” inventors Seth Lee Gilbert, et al., filed Jun. 13, 2019, the entirety of which is incorporated herein by reference.

### BACKGROUND OF THE INVENTION

### Field of the Invention

This present design is directed to identification, authentication, anti-counterfeiting and tracing of items, and more specifically, to unique, inexpensive tags that attach to items, including consumer products, which make the items unique and which can be easily and inexpensively identified, authenticated or traced.

### Description of the Related Art

One consequence of the Industrial Revolution and beyond is that we manufacture thousands-to-millions of the same products, objects or items, which are indistinguishable from each other. Unfortunately, this mass production of identical items creates an opportunity for bad actors or unlicensed manufacturers (collectively, counterfeiters) to make items that are indistinguishable from authentic items. It would be beneficial to offer (i) devices, systems and methods to make these indistinguishable items unique, (ii) simple and low-cost methods of identifying these unique items and (iii) devices, systems and methods to prevent or significantly impede counterfeiters from copying or otherwise thwarting these unique items.

To prevent counterfeiting, previous approaches are often based on special hidden markings or features (holograms, DNA codes, optically changing inks, multi-color threads, invisible inks, micro-text, etc.) that are attached to, embedded in, or part of the assembly of the item and where a person checks if the marking is there or not. Effectiveness of these methods depends on the person knowing where these hidden markings reside on the item. When a counterfeiter becomes aware of these unique elements, the counterfeiter can replicate them, thereby removing any security benefit and resulting in counterfeit items that are even harder to distinguish from those that are authentic.

In addition to counterfeiting, items may be diverted from their intended market and sold without authorization elsewhere, which is known as diversion or gray markets. Devices, systems and methods to also prevent or substantially diminish diversion through traceability would provide advantages over such previous designs. Items that are lost or stolen may benefit from a central database of lost or stolen items and a quick, easy and inexpensive device, system and method to identify and return such lost or stolen items.

Some image capture devices, especially smartphone cameras and apps operated by consumers, are prone to capture images with large variabilities due to variability in lighting (ambient or user-generated), movement of the imaging device resulting in blur, exposure and camera settings (including time and aperture etc.), and these variabilities cause unacceptably large false positives and/or false negatives in item identification, authentication or tracing.

The identification, anticounterfeit and traceability solutions of the prior art have critical drawbacks. For example, the solutions are substantially unreliable because they identify too many items when they are not the identified item (false positives or FPs) or they fail to identify too many items when they are in fact the identified item (false negatives or FNs). The unique elements tend to be expensive and are covert and not readily available for use by distributors, retailers and consumers. The effectiveness of the unique elements depends on secrecy that once compromised render them obsolete, or alternatively, enable a bad actor to replicate the unique element and/or original item such that the resulting counterfeit item is even harder to distinguish from an authentic item.

Further, such prior systems require custom and/or expensive image capture devices and/or image processors, which are not readily available to everyone, including consumers and/or are difficult to use.

In certain designs, for example, at least two different images must be captured by a smartphone user to identify the three-dimensional characteristics of the authentication feature. This increases the complexity as well as the FPs and FNs of authentication. In contrast, in some aspects of the present design, the unique characteristics of the authentication feature are substantially flat with respect to the unique element's (or tag's) substrate and can be captured with only one image, and these characteristics are determined by comparing the authentication feature to calibration standards on the tag, which make the devices, systems and methods easy to use, inexpensive and results in significantly lower FPs and FNs.

There would therefore be a benefit to a design that provides advantages such as image capture devices (including smartphones) and image processors (including cloud computing) that can be used by all persons along the item's chain, from manufacturers, government agencies, distributors and retailers to consumers and resellers, and through the life of the item from manufacture, through sale to an end-user, and even secondary resale from one end-user to another, computer applications residing in the local device (including smartphone applications) and/or the remote device that simplify the process of identification, authentication and/or tracing, relatively low cost of implementation, and/or a very high cost or level of difficulty in copying.

### SUMMARY OF THE INVENTION

According to one embodiment of the present design, there is provided a method for identifying a first tag, comprising capturing, with an image capture device, an image of the first tag, extracting an indicator from the image of the first tag, extracting an image or template of an image of a reference tag from a database using like serial numbers as a matching element, employing an image processing component to match, compare, and analyze individual unique elements present on the first tag and the reference tag, and determining, with the image processor, acceptability of the first tag based at least in part on a minimum percentage or number of matched unique elements.

According to a further embodiment of the present design, there is provided a method for identifying a first tag, comprising illuminating the first tag with a light source of sufficient wavelength, intensity and/or exposure time to change color of a reversible photochromic chemical on the first tag, capturing, with an image capture device, an image of the first tag with the color of the reversible photochromic chemical having been substantially changed by the illuminating, extracting an identifying indicator from the image of the first tag, identifying an image of a reference tag from a database using like identifying indicators between the first tag and the reference tag as comparison or matching elements, using an image processor to compare the photochromic chemical elements of the first tag with photochromic chemical elements of the reference tag, determining, using the image processor, whether the first tag contains at least one reversible photochromic chemical based on a percentage or quantity of matched photochromic chemical elements between the first tag and the reference tag, and determining, using the image processor, validity of the first tag based at least in part on the presence of the reversible photochromic chemical on the reference tag.

According to a further embodiment of the present design, there is provided a method for identifying a tag, comprising capturing, with an image capture device, a first image of the tag in which a reversible photochromic chemical has not substantially changed color, illuminating the tag with a light source of sufficient wavelength, intensity and/or exposure time to change the color of the reversible photochromic chemical, capturing a second image of the tag in which the reversible photochromic chemical has substantially changed color, comparing the first image of the tag with the second image of the tag using an imaging processor, analyzing, using the image processor, elements in the first image of the tag with respect to elements in the second image of the tag, determining, using the image processor, whether the tag contains at least one reversible photochromic chemical based on a percentage or number of matched, dissimilarly-colored photochromic chemical elements in the first image and the second image, and determining, with the image processor, identity of the tag based at least in part on the percentage or number of matched, dissimilarly-colored photochromic chemical elements in the first image versus the second image.

According to another embodiment of the present design, there is provided a method of identifying a tag with at least one unique element having a three-dimensional protrusion or 3D bump protruding above or normal to the surface of the tag, comprising sensing a tactile sensation and/or visual cue from at least one of the three-dimensional protrusions or 3D bumps, in which at least one of the three-dimensional protrusions or 3D bumps protrudes at least 0.2 millimeters above or normal to a surface of the tag, and comparing the tactile sensation and/or visual cue sensed to a reference tag to determine validity of the tag.

These and other advantages of the present design will become apparent to those skilled in the art from the following detailed description of the invention and the accompanying drawings.

### BRIEF DESCRIPTION OF THE DRAWINGS

The present design is illustrated by way of example, and not by way of limitation, in the figures of the accompanying drawings and in which like reference numerals refer to similar elements and in which:

FIG. 1 is a graphic of a tag;

FIG. 2 is a graph showing the tag variations versus allowed error;

FIG. 3 is a flow chart representing the present design;

FIG. 4 is a block diagram representing the present design;.

FIG. 5 is a spectrograph of a typical smartphone torchlight and flash; and

FIG. 6 is a graph showing intensities and exposure times for photochromic chemicals.

### DETAILED DESCRIPTION

The following description and the drawings illustrate specific embodiments sufficiently to enable those skilled in the art to practice the systems and methods described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

The following description refers to “some embodiments” and “some aspects.” Note that “some embodiments” or “some aspects” describe a subset of all of the possible embodiments and aspects but does not always specify the same subset of embodiments or aspects. Further, this does not limit the permutations or combinations of all or parts of embodiments or aspects in the present design.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure. The recitation of numerical ranges by end elements includes all numbers within that range (e.g. 2 to 4 includes 2, 2.3, 3, 3.60, and 4).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

As used in this specification and the appended claims, use of the word “including” means also “including without limitation” unless the content clearly dictates otherwise.

As used in this specification and the appended claims, use of the words “product,” “object” and “item” all include products, items and objects that are to be identified, authenticated or traced, including consumer products, parts of a product, and works in process.

As used in this specification and the appended claims, use of the words “image capture device” includes cameras (including cameras attached to smartphones), scanners, photocopiers, and any other device that captures the features of a tag.

As used in this specification and the appended claims, “authentication” and “tracing” are included in and are subsets of “identification.”

As used in this specification and the appended claims, use of the words “image processor” includes any computing device that, among other things, analyzes, compares, computes, compiles, translates and/or records the pixels, shapes, colors and/or reflectivities of the various pixels and/or shapes in a tag.

As used in this specification and the appended claims, use of the word “database” includes both traditional digital data repositories that may have a single managing authority, which may be closed to public viewing or access without permission, and distributed digital data repositories (known to those skilled in the art as blockchains or distributed ledgers), which may be private, semi-private or fully open to public view, which may be managed by consensus of more than one party, and which may be encrypted such that searching the archive requires knowing specific information such as block height, hash, transaction identification, etc.

The present design improves the accuracy, efficiency and ease-of-use of item identification, authentication and tracing.

The present design may scatter a complex two-dimensional array of pixels or polygons and other shapes (including materials with variable reflectivities and/or colors, e.g. regular polygon, irregular polygon, concave polygon, convex polygon, circular, and/or curved) randomly or pseudo-randomly, over and onto a two-dimensional space (also known as a tag). This tag can be made of paper, cloth, plastic or other materials. In some aspects of the present design, the two-dimensional space can be integrated onto the item or the item's package. These randomly-spaced pixels or shapes make the tag unique, and attached to any tangible item, this tag then makes any item unique and identifiable. Images or descriptions (also known as templates) of these tags are stored in a database, each marked as attached to one item, including information about the item. In some aspects of the present design, these tags also include an alphanumeric serial number, which among other possible reasons, speeds searching within the database. In some aspects of the present design, a smartphone app or other image capture device captures an image of the tag attached to an item and sends the tag's image or template to the image processor and database, in the cloud or locally.

An image processor, possibly using computer vision, machine learning and/or artificial intelligence algorithms, may convert the image to a template. In some aspects of the present design, the template, both stored in the database and uploaded from the smartphone app, includes unique elements or elements about the tag and the item, including one or more of color and/or reflectivity of each shape or pixel, properties of each shape, and/or x-y location of each shape or pixel in the tag's two-dimensional space.

The image processor, again possibly using computer vision, machine learning and/or artificial intelligence algorithms, then compares the template to one or more templates in the database. In some aspects of the present design, the image processor determines a match between a template in the database to the template created from the smartphone app's image by finding a minimum number and/or percentage of unique identifiers or elements between the two templates. In some aspects of the present design, the devices, systems and methods described above effectively provide a ubiquitous, low-cost and simple item identification, authentication and tracing system and method.

In addition, to be effective, some aspects of the present design must also minimize FPs and FNs below an acceptable threshold. Using the present design in real-world situations, the image captured by the smartphone app is prone to errors due to, among other things, variable lighting, movement of the image capture device and/or angle of image capture relative to the tag. Calibration standards or elements (for example, shapes or pixels on the tag with known colors, color temperature/white balance, and/or reflectivities), which may be overtly or covertly placed on the tag's two-dimensional space, can be used by the image processor to normalize a tag's captured image and adjust for variations in image capturing. In addition, it will be difficult for counterfeiters to copy a tag without knowledge of the location and values of the covert calibration elements.

Finally, to be effective, some aspects of the present design must also be very expensive and/or difficult-to-impossible for counterfeiters to copy. In some aspects of the present design, chemicals that reversibly change color when exposed to a minimum of light wavelength, intensity and/or exposure time (photochromic chemicals) are overtly or covertly added to the tag, and if the image capture algorithm (including torchlight time and intensity as well as flash time and intensity) are covertly adjusted to change the color of the photochromic chemical, then the image captured will be different than the image captured using a conventional smartphone camera, photocopier and/or scanner. In some aspects of the present design, if these custom photochromic chemicals are added to the tag and the smartphone app contains a custom, unique image capture algorithm, the tag will contain a covert, unique element that will not be able to be detected or copied by counterfeiters. There is always the fear among users that two-dimensional identifiers can be eventually copied by counterfeiters. In some aspects of the present design, three dimensional protrusions or 3D bumps may be added to the tag (either alone or as part of one or more unique elements), which 3D bumps are sufficiently thick that a user can verify through touch or visual assessment of texture that the unique element has not been printed using conventional two-dimensional printers.

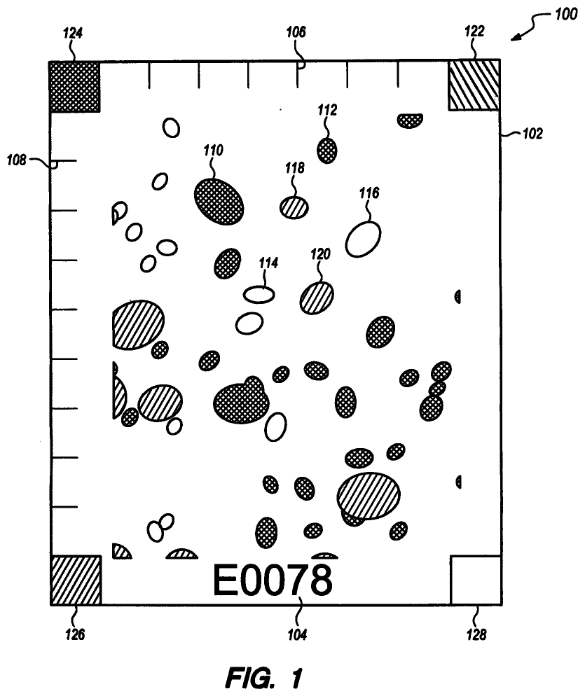

A one-of-a-kind tag affixed to one-of-many items makes the item unique. In some aspects of the present design, the tag is unique, inexpensive and difficult or costly to copy. In turn, this tag makes identification, authenticating or tracing an item difficult or costly to copy. FIG. 1 shows a graphic of a typical tag used in some aspects of the present design to identify, authenticate or trace an item. The tag 100 incorporates both visible and hidden unique elements. In some aspects of the present design, the tag's substrate 100 is two-dimensional. In some aspects of the present design, the tag's substrate 100 can be paper, plastic or fabric; and in some aspects of the present design, the tag can even be integrated directly into or onto an item or the item's package. In some aspects of the present design, the tag 100 can be part of an adhesive lamination with variable adhesive bonding strengths or tamper-proof layers or a perforated substrate 100 that is affixed to an item such that the tag 100 is destroyed or visibly degraded if the tag 100 is removed from the item.

Tag 100 may have a substantially clear coating to protect the tag's substrate 100 and elements 102-126 from wear, water, chemicals, or the environment. The tag 100 is unique when one or more of its elements 110-120 are unique, meaning that one or more of their properties (including x-y locations, shapes, colors, reflectivities, etc.) are different for each tag. The visible unique elements 110-120 (excluding the hidden unique elements) aid in the tag's uniqueness and help the user locate and identify the tag and item. The hidden unique elements 110-120 (excluding the visible unique elements) also aid in the tag's uniqueness and prevent copying and counterfeiting. In some aspects of the present design, the tag's unique elements are bounded by a box 102, which aids in visible identification and assists computer vision software in reorienting the tag if the tag's image is captured off angle from normal to the tag's substrate 100. This box 102 may also include hash marks 106 and 108, which provide measurement clues, aiding the computer vision software in determining the x-y coordinates of the unique elements 110-120 in the two-dimensional tag substrate 100. In some aspects of the present design, the tag 100 includes a unique serial number 104 that is used by the computer vision software and matching software to more quickly find the matching image or template in a database of one or more images or templates.

For identification, authentication or counterfeit detection of an item among numerous seemingly similar items, the present design stores unique elements attached to these items in a database as a template; and for each item, the unique elements of that item are compared to the unique elements stored in the database to determine if there is (i) a match to the identified, authentic, unique elements and items in the database, (ii) a match to known unidentified or counterfeit identifiers and items in the database, and/or (iii) not a match in the database indicating that the item is most likely not identified or authentic.

In some aspects of the present design, one or more unique elements of the tag 100 include colored shapes or pixels 110 and 112. These colored shapes or pixels 110 and 112 are effectively four dimensional in that they contain (i) the unique, two-dimensional x-y coordinates of individual colored pixels or shapes in the tag (ii) the unique shapes resulting from commonly colored pixels that are connected, and (iii) the unique colors of individual pixels and/or shapes. If, for example, the active area of a tag 100 (comprising the area inside the hash marks 106 and 108) is 1 inch×1 inch, the resolution of colored pixels on the tag is merely 100 pixels per inch (PPI) and the color possibilities are 8 bits (i.e. 256 possibilities of red, green and blue=256³=16,777,216 color possibilities), then this simple tag 100 with only color elements will have almost 170 billion tag variations.

In some aspects of the present design, one or more unique elements of the tag 100 include shapes or pixels 114 and 116 that are reflective. These reflective shapes or pixels 114 and 116 are effectively four dimensional in that they contain (i) the unique, two-dimensional x-y coordinates of individual reflective pixels or shapes in the tag (ii) the unique shapes resulting from commonly reflective pixels that are connected, and (iii) the unique reflectivity (i.e. 0% to 100%) of individual pixels and/or shapes. In some aspects of the present design, some of the reflective shapes and/or pixels 114 and 116 may have different colors. Because variable reflective elements cannot presently be copied using conventional photocopying technologies, reflective elements are difficult-to-impossible to replicate cost-effectively.

In some aspects of the present design, reflective elements 114 and 116 have variable reflectivity; and without calibration, it is almost impossible for a counterfeiter to copy these variable reflective elements effectively because the counterfeiter will not be able to cost-effectively measure each reflective element and replicate them accurately on a copied, inauthentic tag. When light is incident on a surface, two types of light are reflected—diffuse and specular. Reflectivity is defined as the light received at the image capture device as a percentage of the light that is incident on the tag 100. Theoretically, for a 100% reflective surface, the amount of light received would equal the amount of light incident on the tag. Different pixels and/or shapes are variably reflective when the reflectivity is different from one pixel and/or shape to the next.

Several factors affect reflectivity, including angle of incidence and reflection of incident light f(rom the flash or ambient light) and/or proximity of the image capture device to the flash, surface texture of the reflective element (including smooth, dimpled, and/or patterned), gloss of the reflective element's surface as measured in Gloss Units (GU), and amount of light transmitted through the reflective element, absorbed and/or reflected back.

Using sophisticated, limited-availability printers, including those that use liquid electrophotography technology, or similar means, to deposit and adhere curable polymers, electrically charged inks, dyes, particulates, and foils onto a substrate to different heights, and in single-to-multiple layers, such as Scodix (scodix.com), in some aspects of the present design, variable reflective elements 114 and 116 can be cost-effectively added to a tag 100.

Some aspects of the present design use photochromic chemicals to identify, authenticate and trace tags and items. Photochromic chemicals change color after absorbing sufficient light energy—wavelength, intensity and/or exposure time. For a fixed wavelength, the color of the photochromic chemical will change after a threshold exposure time and/or intensity. Some photochromic chemicals are reversible in that they change back to substantially their original color a certain time after the light energy is turned off. Most photochromic chemicals work in the ultraviolet, but some recent photochromic chemicals change color in the 400 to 500 nanometers wavelength range. Smartphones with integrated cameras usually have a light source used to illuminate, partly to focus the camera, (known as the torchlight) and then flash the object of image capture, usually with the same light source but with an increased intensity. Usually a smartphone's light source is mostly white, but it originates as a 450 nanometers blue light emitting diode (LED) in which part of the blue is absorbed by chemicals and reemitted as red and green, thereby producing a mixed, substantially white light source. Given the right photochromic chemical, a smartphone's light source can change the color of the photochromic chemical. In some aspects of the present design, a photochromic chemical is added to the tag 100 in one or more various shapes and colors 118-120. When capturing an image, under normal operating conditions, a smartphone turns on the torchlight (lower intensity) for about two seconds and then flashes the light (higher intensity) for a fraction of a second while the image capture device in the camera absorbs the light redirected from the item.

In some aspects of the present design, the photochromic chemical elements 118-120 on the tag 100 do not substantially change their color under such normal operating conditions of the image capture device. However, in some aspects of the present design, the initial torchlight illumination (intensity and/or exposure time) is increased sufficiently to substantially change the color of the photochromic chemical elements 118-120 in the tag 100. In some aspects of the present design, some color elements 124-128 and/or 110-112 include photochromic calibration elements or elements which are substantially the same color as the photochromic chemical elements 118-120 after the color change. In some aspects of the present design, the image processor measures the similarities or differences between the photochromic chemical elements 118-120 and the calibration elements 124-128 and/or 110-112 to determine whether a color change has occurred in the photochromic chemical elements 118-120. If the photochromic chemical elements 118-120 and/or the special image capture algorithm (increased intensity and/or exposure time of the torchlight and/or flash beyond the normal intensity and/or time) are not known to counterfeiters, then counterfeit tag images will not contain the color elements 118-120 with the changed color. Therefore, in some aspects of the present design, under normal operating conditions of the smartphone, which would be used by a counterfeiter, there will be a sufficient difference between the counterfeit color elements 118-120 (either because the color element 118-120 is the pre-exposed color or the normal image capture lighting algorithm was insufficient to change the color) and the calibration elements 124-128 and/or 110-112 to identify the tag as counterfeit or not authentic.

Conversely, in some aspects of the present design, under special extended operating conditions of the smartphone, there will be sufficient similarities between the photochromic chemical elements 118-120 (because the photochromic chemical elements 118-120 changed under the extended image capture lighting algorithm) and the photochromic calibration element 124-128 and/or 110-112 to identify the tag.

Under such circumstances, photochromic chemical elements 118-120 are sufficiently unique to make the tag 100 and object unique while at the same time sufficiently covert (both in location and process) to thwart counterfeiting.

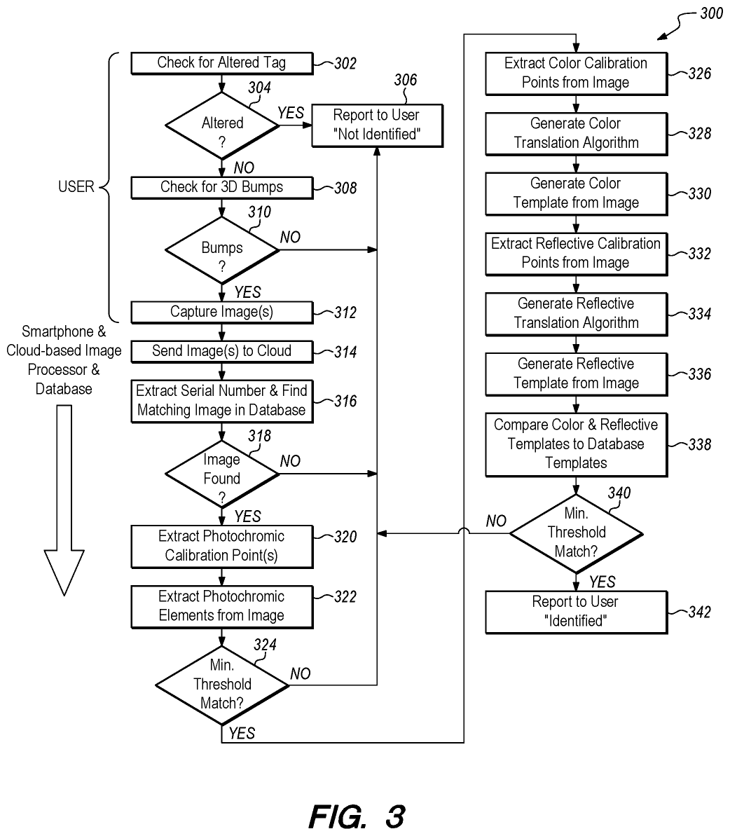

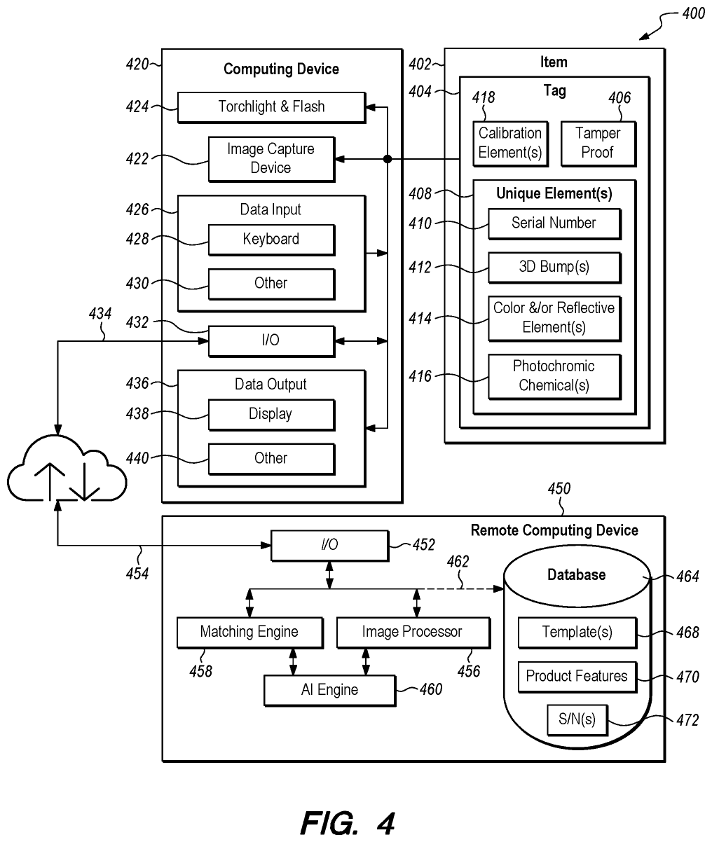

To minimize FPs and FNs, in some aspects of the present design, the image capture device and image processor (see FIGS. 3 and 4 below) should accurately detect these various colors and variable reflective elements without being impeded by significant noise factors (including variable angles, variable lighting, blur, speed and aperture settings, and/or other user errors). For example, if a unique element 110 in the tag 100 is accurately stored in the database as one color and/or reflectivity, and the same unique element 110 in the tag 100 is captured in the real world by a smartphone camera and analyzed by an image processor as another color and/or reflectivity, then the image matching algorithm of the image processor will incorrectly report that these two elements are not a match when in fact they are a match (i.e. a false negative or FN). As another example, if a unique element 110 in the tag 100 is accurately stored in the database as one color and/or reflectivity, and the different unique element 110 in a different tag 100 is captured in the real world by a smartphone camera and analyzed by an image processor as the same color and/or reflectivity, then the image matching algorithm of the image processor will incorrectly report that these two elements are a match when in fact they are not a match (i.e. a false positive or FP). If a sufficient number or percentage of the FNs or FPs accumulate in the matching algorithm of a tag 100 compared to a tag in the database, the image processor will incorrectly report to the user that the tag is identified or authentic when in fact it is not identified or authentic (FP) or incorrectly report to the user that the tag as not identified or authentic when in fact it is identified or authentic (FN).

In some aspects of the present design, the deleterious effects of the angle of incidence and reflection of incident light and proximity of camera to light source and other errors are minimized by adding calibration elements 122-128 to the tag 100. In real-world situations, the image captured by the smartphone app is prone to errors due to, among other things, variable lighting, movement of the image capture device and/or angle of image capture relative to the tag. Calibration standards 122-128 (for example, shapes or pixels on the tag with known colors and/or reflectivities), which may be overtly or covertly placed on the tag's two-dimensional space, can be used by the image processor to normalize a tag image and adjust for real-world variations in image capture. In some aspects of the present design, a calibration standard, for example, with a known color (e.g. red 255:0:0 for 8-bit red:green:blue) and/or a known reflectivity (e.g. 50%) can be placed in the top right corner 122 of the tag 100.

The image or template of the tag 100 stored in the database would contain a substantially true or accurate representation of this color and/or reflectivity 122 because the image or template of the tag 100 stored in the database was created or derived in best-case conditions (i.e. from data stored at the time of template creation that has a substantially complete and true mathematical, physical, optical and/or x-y record of all unique elements, including white balance, color number codes (hexadecimal RGB), element position, element type, and/or element height etc.) and contains a substantially accurate image capture and/or template. Thus, the calibration corner 122 of the tag 100 in the database, would contain a substantially accurate representation of red and 50% reflectivity; and the other colored and/or reflective elements 110-120 in the tag 100 in the database would be a substantially accurate representation of their colors and/or reflectivities. Then, when an image of a tag 100 is captured with an image capture device (in real-world conditions) and when the image processor measures the calibration element 122 and detects a color other than red (255:0:0) and 50% reflectivity, the image capture device and/or image processor can generate a translation algorithm (e.g. linear or non-linear translation) to translate the captured elements 110-128 to a closer representation of the substantially accurate representations of the elements 110-128 stored in the database. Then, the same translation algorithm can be used to translate the unique elements 110-120 in the tag 100 to a substantially accurate representation of each of their colors and/or reflectivities. Further, in some aspects of the present design, this calibration process can rely on more than one calibration element for the purposes of enhanced accuracy and reduced FPs and FNs. For example, in the above referenced scenario of detecting the color red, the translation algorithm could also incorporate a reference element 110-128 known to be true white such that the lighting variations and translation can most accurately reflect both color and color temperature/light intensity. In this manner, the real-world errors created by users of smartphones can be substantially corrected.

In some aspects of the present design, the calibration elements can instead be one or more of the elements 110-120, covertly hidden among the other unique elements, which prevents counterfeiters from knowing and exploiting these calibration elements. The more calibration elements overtly used 122-128 and/or covertly used 110-120 with varying colors and/or reflectivities, the more accurate the translation algorithm. In short, it will be difficult for counterfeiters to copy a tag without knowledge of the location and values of the covert calibration elements. In sum, covert calibration elements hidden among the other unique elements 110-120 of the tag 100 can effectively correct for real-world errors using a smartphone camera as well as make it more difficult for counterfeiters to copy the tag 100.

In some aspects of the present design, three-dimensional protrusions or 3D bumps are added to the tag 100. These 3D bumps protrude physically above the two-dimensional space of the tag 100. In some aspects of the present design, these 3D bumps will protrude sufficiently above the two-dimensional space of the tag 100 that a person will be able to visually see the textural variations and/or feel these bumps when the person touches, feels or otherwise rubs the tag 100. It is impossible for two-dimensional printers, scanners and copiers to replicate these 3D bumps, and it is extremely difficult and costly for counterfeiters to copy these 3D bumps using sophisticated, limited-availability printers. In some aspects of the present design, the user or authenticator of the tag 100 will effectively identify or authenticate a tag 100 (or unauthenticate a tag 100) by merely touching, feeling or rubbing the tag 100, seeking the presence or absence respectively of 3D bumps on the tag. In some aspects of the present design, the user or authenticator of the tag 100 will effectively identify or authenticate a tag 100 (or unauthenticate a tag 100) by merely looking at the surface of the tag 100, possibly at an oblique angle in front of a light source, seeking the presence or absence respectively of 3D bumps on the tag. In effect, the 3D bumps serve as physical unique elements of the tag 100. In some aspects of the present design, the 3D bumps are part of the unique elements 110-120 of the tag 100. In some aspects of the present design, the 3D bumps are in addition to the unique elements 110-120 of the present design.

In some aspects of the present design, images of the tag 100 are converted to templates in order to increase the speed and decrease the FPs and FNs. In some aspects of the present design, one or more of the following template elements of a tag's image are used to compare a tag's 100 template to templates in a database:
x-y coordinates of color, reflective and/or photochromic elements;
characteristics of the shapes of the color, reflective and/or photochromic elements (e.g. regular polygon, irregular polygon, concave polygon, convex polygon, circular, and/or curved);
size of the color, reflective and/or photochromic elements;
whether elements of different colors and/or reflectivities are touching or overlapping;
color of the color, reflective and/or photochromic elements;
reflectivity of the reflective elements; and/or
x-y coordinates of 3D bumps.

However, in order to obtain the full variability of tags, in some aspects of the present design, the image itself will be the template that is compared pixel-by-pixel to the image in the database.

Each tag 100 must be unique. In some aspects of the present design, computer programs with pseudo-random number generators are used to generate digital tags 100 that can be generated and created using digital computers. As stated above, in some aspects of the present design, sophisticated digital printers then print these tags 100 very cost effectively and quickly, which incorporate one, several or even all of the elements described above. Alternatively, in some aspects of the present design, the tag can be created by printing or spraying one or more of the different elements onto the tag's substrate 100 or the item directly.

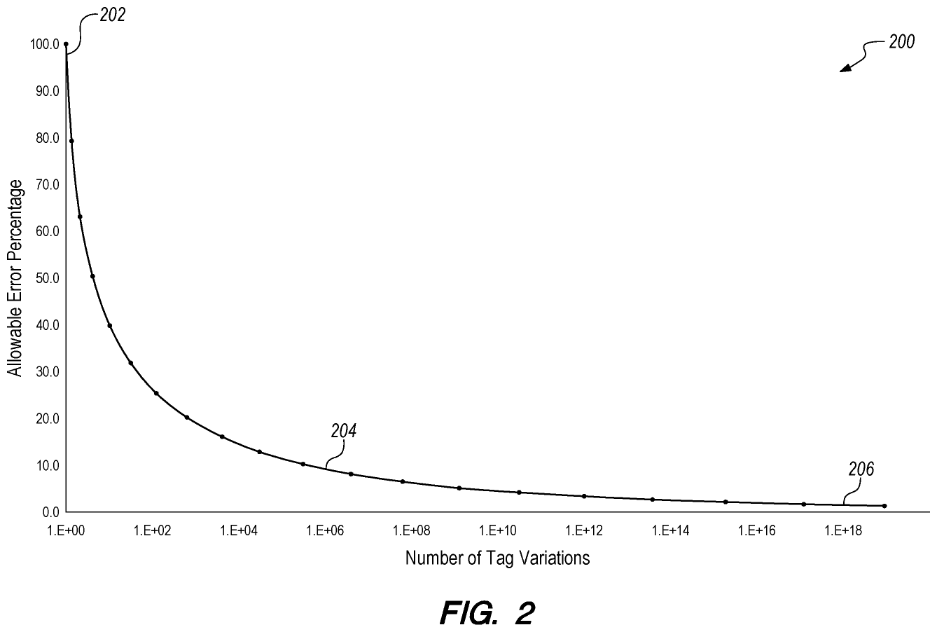

As the number of unique tags 100 (also known as tag variations) increases, the number and/or properties of individual unique elements 110-120 increases. In an erroneous image capture, variable lighting, blurring, oblique angle and/or poor image processing algorithms can cause the individual elements 110-120 in a tag 100 to have different and erroneous properties (including x-y location, color, reflectivity etc.), and this in turn increases the number of possible tags with the seemingly same unique elements in an erroneous capture of tags' images. In short, the allowable errors in the properties (including x-y location, color, reflectivity etc.) of the unique elements 110-220 of a tag 100 decrease exponentially as the number of tag variations increases. Allowable errors or allowable error percentage is defined as the range of errors in the properties (including x-y location, color, reflectivity etc.) of unique elements 110-120 in a tag 100 while still achieving acceptably low levels of FPs and FNs in the image matching with tags in the database. Put another way, for a given image capture and image processing technology, the numbers of FPs and FNs increase exponentially as the number of tag variations increase. This is shown in FIG. 2 as an exponential decrease 200 in allowable errors as the tag variations increase.

At the most basic level, a tag 100 with only one variation would include only one unique element 110-120, and the tag 100 would be deemed identified or authentic if the singular unique element 110-120 existed anywhere in the tag space 100, regardless of the unique element's properties or location. This can be shown in 202 of FIG. 2 where there is only one tag variation and the allowed error is 100%. In some aspects of the present design, as the number of tag variations increases to about 10⁶ 204, the allowable errors drop dramatically. In some aspects of the present design, the number of tag variations must eventually be very large 206 to thwart the large counterfeiting industry, so the allowed error percentage (to prevent unacceptable levels of FPs and/or FNs) is very small.

In some aspects of the present design, the tag 100 will initially have an acceptably low number of variations (about 10⁷ to 10⁸) 204 in order to accommodate the earlier versions of smartphone image capture and image processing while still achieving acceptably low FPs and FNs. In some aspects of the present design, as the errors are reduced over time in smartphone image capture and image processing (including improved uses of computer vision, artificial intelligence, lighting and image capture), the tag variations can increase to much larger numbers 206 to accommodate increase market size without sacrificing FPs and FNs. In some aspects of the present design, these tags 100 with increased variations do not overlap but rather are downwardly compatible with the earlier tags 100 with lower variations.

In one aspect of the present design, FIG. 3 is a process flow chart showing the general steps in identifying a tag and item upon which the tag is attached. Such a process may be performed in part using a computing device, including a computing device with an image processor or image processing capability. The typical process 300 of identifying a tag and item starts 302 by the user or authenticator checking the tag for visible destruction or degradation. As noted above, the tag 100 can be part of an adhesive lamination with variable adhesive bonding strengths, tamper-proof layers or a perforated substrate 100 affixed to an item such that the tag 100 is substantially altered or fully destroyed if the tag 100 is removed from the item. In some aspects of the present design, the user physically checks the tag 302 to determine if it has been removed or tampered with 304, which indicates that the tag and item are reported to the user as not identified or not authentic 306. Second, the user may see, touch, feel and/or rub the tag 308 to determine if the tag's surface has protrusions or 3D bumps indicative of an identified or authentic tag. If the tag does not contain 3D bumps 310, the tag and item are reported to the user as not identified or not authentic 306. Then, the user may capture an image of the tag 312 using an image capture device such as a smartphone camera. In some aspects of the present design, the ease of use of the present design is obvious in the fact that the user's involvement in identifying or authenticating a tag, or item upon which the tag is attached, is limited to one or more of these three initial, simple steps—(i) checking for tag's alteration 302, (ii) checking for 3D bumps 308 and/or (iii) capturing the tag's image 312. In some aspects of the present design, the smartphone app sends the image to the cloud-based computing device 314. In some aspects of the presents design, some and/or all of the steps 316-342 can be performed by the computing device and/or database residing locally in the smartphone. In some aspects of the present design, the computing device extracts the serial number attached to the tag and searches the database for a matching serial number and tag 316. If no matching serial number and tag are present in the database 318, the tag and item are reported to the user as not identified or not authentic 306. In some aspects of the present design, a serial number is not needed on the tag because the image processor will match tags or tag's templates to tags and templates in the database directly. In some aspects of the present design, at this stage the image processor converts the tag's image to a template to directly compare, analyze and match to templates in the database. The templates are a description of the unique elements of the tag. The template, both stored in the database and uploaded from the smartphone app, may include unique elements about the tag and the item, including one or more of the following:
x-y coordinates of color, reflective and/or photochromic elements;
characteristics of the shapes of the color, reflective and/or photochromic elements (e.g. regular polygon, irregular polygon, concave polygon, convex polygon, circular, and/or curved);
size of the color, reflective and/or photochromic elements;
whether elements of different colors and/or reflectivities are touching or overlapping;
color of the color, reflective and/or photochromic elements;
reflectivity of the reflective elements; and/or
x-y coordinates of 3D bumps.

Storing, uploading, comparing, matching and/or analyzing templates of tags may be quicker and more efficient than storing, uploading, comparing, matching and/or analyzing images of tags. Visual representation of the tag may be by any means available and practical. For example, while taking a photo with a smartphone is discussed herein, any manner of obtaining a graphical representation may be employed, and the processing of the visual representation is of importance, including comparison with known representations, etc.

In some aspects of the present design, the image processor extracts photochromic chemical calibration elements from the tag's image 320. The image processor may extract certain properties of the photochromic chemical calibration elements (including shapes and/or x-y locations) from the tag's database and then uses these descriptions to extract the photochromic chemical calibration elements in the captured tag's image. Alternatively, in some aspects of the present design, the image processor extracts photochromic chemical calibration elements from the tag by searching for elements within a certain color range, shape range and/or specific x-y location, either globally known or extracted from the tag's description stored in the database. Then, the image processor compares the properties of the photochromic calibration elements (including color, x-y location etc.) to the photochromic chemical calibration elements in the database to compute errors and generate translation algorithms (linear or non-linear) to correct for these errors between the truer image in the database to the possibly erroneous image captured by the image capture device. The image processor may extract the unique photochromic chemical elements from the tag's image 322 captured by the smartphone's image capture device. Next, the image processor corrects for any errors in the properties of the unique photochromic chemical elements by applying the translation algorithms to the properties of the unique photochromic chemical elements. Then, the image processor analyzes, compares and scores the properties of each photochromic chemical element captured and extracted from the tag to the tag's properties stored in the database, and then determines if there is a match between the captured tag and the tag stored in the database by calculating a minimum number and/or percentage of matches in the whole tag space 324. If the number and/or percentage of matches does not meet a minimum threshold, the user is notified that the tag and item are not identified or not authentic 306.

In some aspects of the present design, the image processor extracts color calibration elements from the tag's image 326. The image processor may extract certain properties of the color calibration elements (including colors, shapes and/or x-y locations) from the tag's database and then uses these descriptions to extract the color calibration elements in the captured tag's image. Alternatively, in some aspects of the present design, the image processor extracts color calibration elements from the tag by searching for elements within a certain color range, shape range and/or specific x-y location, either globally known or extracted from the tag's description stored in the database. Then, the image processor may compare the properties of the color calibration elements (including colors, shapes, reflectivities, x-y location etc.) to the color calibration elements in the database to compute errors and generate translation algorithms (linear or non-linear) to correct for these errors between the truer image in the database to the erroneous image captured by the image capture device 328. The image processor extracts the unique color elements from the tag's image captured by the smartphone's image capture device and creates a template by extracting certain properties of each unique color element, including colors, shapes, x-y locations etc. Next, the image processor corrects for any errors in the properties of the unique color elements by applying the translation algorithms to the properties of the unique color elements and saves these locally as a color template of the tag's image 330.

The image processor may extract reflective calibration elements from the tag's image 332. In some aspects of the present design, the image processor extracts certain properties of the reflective calibration elements or elements (including colors, reflectivities, shapes and/or x-y locations) from the tag's database and then uses these descriptions to extract the reflective calibration elements in the captured tag's image. Alternatively, in some aspects of the present design, the image processor extracts reflective calibration elements from the tag by searching for elements within a certain color or reflectivity range, shape range and/or specific x-y location, either globally known or extracted from the tag's description stored in the database. Then, the image processor compares the properties of the reflective calibration elements (including colors, shapes, reflectivities, x-y location etc.) to the reflective calibration elements in the database to compute errors and generate translation algorithms (linear or non-linear) to correct for these errors between the truer image in the database to the erroneous image captured by the image capture device 334. Then, the image processor extracts the unique reflective elements from the tag's image captured by the smartphone's image capture device and creates a template by extracting certain properties of each unique color element, including colors, shapes, x-y locations etc. Next, the image processor corrects for any errors in the properties of the unique color elements by applying the translation algorithms to the properties of the unique color elements and saves these locally as a color template of the tag's image 336.

Finally, the image processor analyzes, compares and scores 338 the properties of each color and/or reflective element captured and extracted from the tag to the tag's properties stored in the database and then determines if there is a match between the captured tag and the tag stored in the database by calculating a minimum number and/or percentage of matches in the whole tag space 340. If the number and/or percentage of matches does not meet a minimum threshold, the user is notified that the tag and item are not identified 306. However, if the number and/or percentage of matches meets the minimum threshold, the user is notified that the tag and item are identified 342. In some aspects of the present design, the color and reflective elements are the same, in which case system merges the process steps of 326 and 332, 328 and 334, and 330 and 336 together.

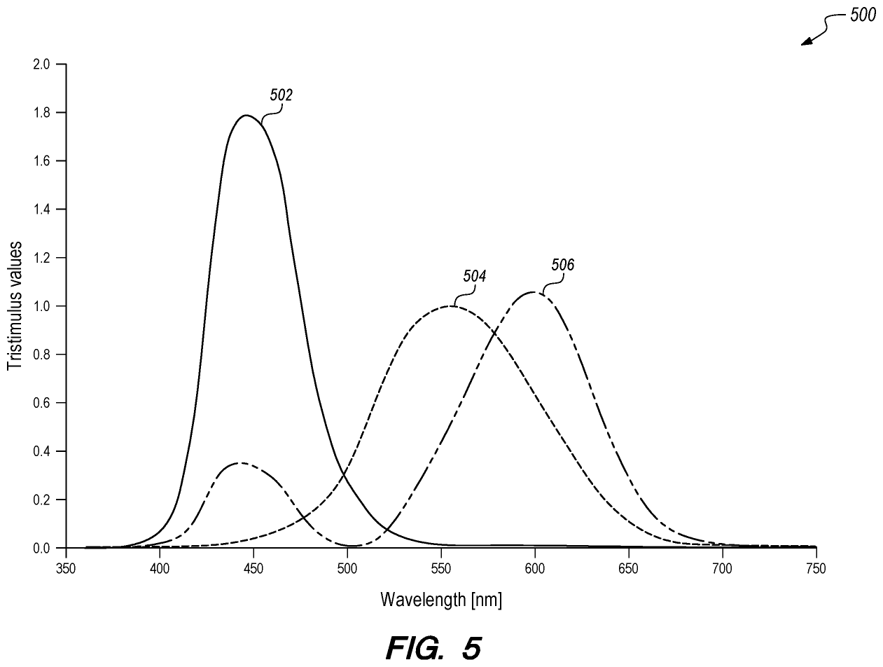

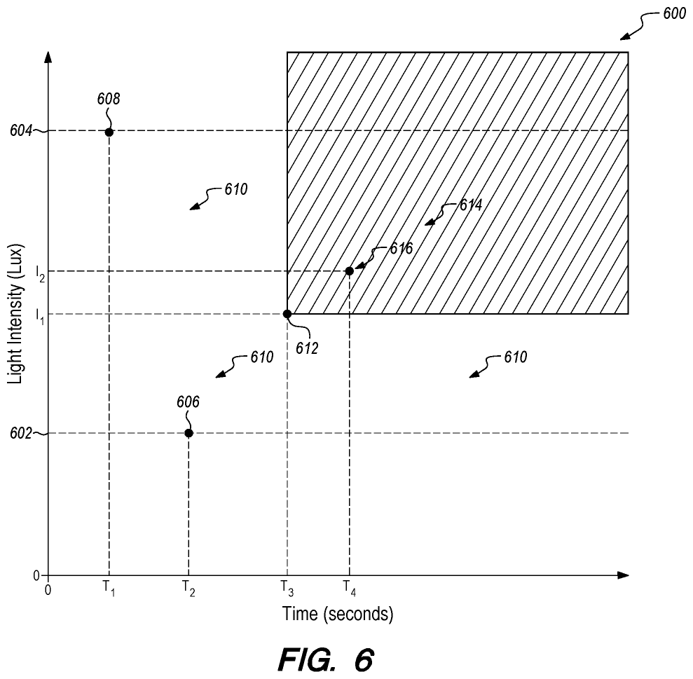

In some aspects of the present design, instead of photochromic chemical calibration elements, the image processor uses the color translation algorithms (see below) and properties of the photochromic chemical elements stored in the database to calibrate the photochromic chemical elements. See the descriptions in FIGS. 5 and 6 below for a detailed description of how these photochromic chemical calibration elements and/or unique elements are extracted from the tag. Then the image processor compares the properties of the photochromic chemical elements—including colors, shapes, x-y locations etc.—with the properties of the photochromic chemical elements in the database for the tag to determine how many and/or percentage photochromic chemical elements match.

In some aspects of the present design, the tags or templates of known counterfeit and/or stolen or lost items are stored in the database, and when there is a match, the user is notified that the item is definitely counterfeit or lost/stolen respectively. In some aspects of the present design, additional data on the item are stored in the database along with the tag, template and/or serial number—including descriptions of the item, ownership information on the item, etc.—which aid in identifying, authenticating, tracing or buying/selling the item. In some aspects of the present design, there are up to six stages—(i) tag degradation, (ii) 3D bumps, (iii) serial number, (iv) photochromic chemicals, (v) colors and (vi) reflectivities—where the tag and item are reported as not identified, but the tag preferably meets up to all six stages for the tag and item to be identified. In some aspects of the present design, FPs are more deleterious than FNs, so this multiple-stage approach errs on the side of FNs to achieve very low FPs. It will be appreciated that the process steps in FIG. 3 are just one of many permutations and/or combinations of the present design, and that in some aspects of the present design, the process steps can be interchanged without affecting the teachings or overall concepts presented herein.

When the tag and item are identified, authenticated or traced and communicated back to the user 342, certain details of the item (including item name, item serial number, item image etc.) may be communicated back to the user by the remote computing device via the smartphone camera. This enables the user to understand more about the details of the item as well as serve as one final identification and/or authentication of the item. For example, if the tag and item are reported back as identified or authenticated but the item description does not match the item upon which the tag is attached, then the item is not ultimately identified, authenticated or traced. In some aspects of the present design, the user or authenticator has the option to report this information back to the remote computing device and database.

The process flow of the representation in FIG. 3 is shown diagrammatically in FIG. 4. The computing device 420 captures images from the item 402 and tag 404. As stated above, the user or authenticator initiates the process described in FIG. 3 above by inputting a start sequence via the data input devices 426, comprising either the keyboard 428 and/or other input devices 430, including voice through a microphone or other transducer. Other computing devices and/or hardware components may be employed while still offering the functionality described herein. In some aspects of the present design, the user inputs the serial number or other information of the item 402 or tag 404 manually via the data input devices 426. In some aspects of the present design, the torchlight and/or flashlight 424 of the computing device 420 are used to aid in capturing the image of the tag 404, including the tag's calibration elements 418 and unique elements 408 and/or change the colors of the photochromic chemical elements 416. In some aspects of the present design, the I/O 432 portion of the computing device 420 then transmits the tag's 404 image wirelessly 434 through the network 454 to the remote computing device 450 and its I/O device 452 to the image processor 456 via the internal bus 462. Then in some aspects of the present design, the image processor 456, coupled possibly with the AI Engine 460, converts the image to a template representing the properties (including colors, shapes, reflectivities, x-y locations etc.) of the calibration elements 418 and unique elements 408 of the tag 404, and these properties are compared and matched using the Matching Engine 458 to the same serial-numbered 472 tag properties 468 in the database 464. The results of the matching algorithm, along with other item features 470, using the Matching Engine 458 and possibly the AI Engine 460, are transmitted back to the user via the wireless network 454 and 434 to the computing device 420 and reported to the user via the data output 436 of the computing device, including one or more of the display 438 or other output devices 440, including audio through a speaker or other transducer.

In some aspects of the present design, photochromic chemicals 416 serve as unique elements in the tag 404, but to be used in a smartphone application, these photochromic chemicals must be tailored to the image-capture parameters of a smartphone. The photochromic chemical must change color under the wavelength of light (torchlight and/or flashlight) from a light emitting diode (LED) emitted from a smartphone when capturing an image, albeit possibly under increased intensity and exposure time. FIG. 5, shows the tristimulus values versus wavelength for light (torchlight and flash) emitted from a smartphone. In most smartphones, the torchlight is the LED under lower intensity, which is used to illuminate the object to be captured, and the flash is the same LED under higher intensity for fully illuminating the item to be captured during the actual image capture. FIG. 5 shows the intensities of light 500 emitted from an LED provided by Lumileds for the Apple iPhone. The primary LED emits blue light with a peak wavelength around 450 to 460 nanometers 502. Then, chemicals near the LED absorb some of the blue light and reemit light as green at around 560 nanometers 504 and red at around 600 nanometers 506. The combination of blue, green and red 502-506 results in substantially white light for illumination and flash.

In some aspects of the present design, the blue peak wavelength 502 is absorbed by the photochromic chemical elements 118-120 in the tag 100 to create one or more effective, covert, unique elements of the tag. Further, in some aspects of the present design, the photochromic chemical elements and/or photochromic chemical calibration elements are especially configured to change color not under the normal torchlight and flash process of a smartphone camera but instead only under the special torchlight and flash process set forth herein. In this manner, the photochromic chemical elements and photochromic chemical calibration elements remain covert to counterfeiters and thwart copying. FIG. 6 is a graph showing light intensity (Lux) versus time (seconds) for a photochromic chemical 600 used in one aspect of the present design. As stated above, the basic process for any photochromic chemical is that for a given wavelength of light the photochromic chemical's color (Color1) changes substantially to (Color2) after being exposed to a minimum intensity (Lux) and time (seconds), shown as 612 with a minimum intensity (I₁) and exposure time (T₃). The photochromic chemical is reversible if after a given time, the Color2 will revert back substantially to Color1.

In some aspects of the present design, the photochromic chemical is designed to react to light with a peak wavelength at around 400 to 500 nanometers and the initial, pre-exposure Color1 of the photochromic chemical is shown in 610. In 610, the photochromic chemical has not received enough intensity and/or exposure time to substantially change color. However, after a minimum light intensity and/or exposure time, the photochromic chemical changes from Color1 610 to Color2 614. It is known that photochromic chemicals degrade over time. In some aspects of the present design, the Color1 610 image is captured and then after exposure, the Color2 614 image is captured, and then photochromic chemical elements are detected by the image processor if there is a minimum relative change between Color1 610 and Color2 614 and not absolute values using photochromic chemical calibration elements. In this manner temporal or environmental changes in Color1 and/or Color2 over time can still be used by some aspects of the present design.

A typical smartphone image capture process is shown in FIG. 6. As a typical image capture starts, the torchlight illuminates 606 light at a lower intensity 602 of about 2,000 Lux for about two seconds (T₂). The purpose for this initial illumination is to aid on the automatic focus of the smartphone camera. Then, the flash illuminates 608 at a much higher intensity 604 for a fraction of a second (T₁) to fully illuminate the tag to be captured by the smartphone's camera. In some aspects of the present design, the unique photochromic chemical elements 118-120 and photochromic chemical calibration elements are designed such that the Color1 610 does not change to Color2 614. In this manner, a counterfeiter using a typical smartphone camera, scanner or printer will not see Color2 in the tag and will inaccurately copy the tag. If these copied tags are used by some aspects of the present design, the smartphone app and/or remote computing device will report appropriately that the tag and item are “Not Identified.”

In contrast, in some aspects of the present design, the smartphone app's image capture process is modified such that the combined initial torchlight intensity (I₂) and/or exposure time (T₄) exceed the minimum threshold 612 intensity (I₁) and/or exposure time (T₃) 612 to change the photochromic chemical's color from Color1 to substantially Color2 or to change the color sufficiently from Color1 to be detected by the image processor. In such a manner, the smartphone app and/or remote computing device will report appropriately as the tag and item are “Identified.”

FIGS. 1 and 3-6 are provided as examples of item identification, authentication and tracing environments in which certain aspects of the present design may be implemented. It should be appreciated that FIGS. 1 and 3-6 are only exemplary and are not intended to assert or imply any limitation with regard to the environments in which aspects or embodiments of the disclosed aspects or embodiments may be implemented. Many permutations or combinations of the different aspects or embodiments can be accomplished in the present design. Many modifications to the depicted environments may be made without departing from the spirit and scope of the present design.

According to one embodiment of the present design, there is provided a method for identifying a first tag, comprising capturing, with an image capture device, an image of the first tag, extracting an indicator from the image of the first tag, extracting an image or template of an image of a reference tag from a database using like serial numbers as a matching element, employing an image processing component to match, compare, and analyze individual unique elements present on the first tag and the reference tag, and determining, with the image processor, acceptability of the first tag based at least in part on a minimum percentage or number of matched unique elements.

According to a further embodiment of the present design, there is provided a method for identifying a first tag, comprising illuminating the first tag with a light source of sufficient wavelength, intensity and/or exposure time to change color of a reversible photochromic chemical on the first tag, capturing, with an image capture device, an image of the first tag with the color of the reversible photochromic chemical having been substantially changed by the illuminating, extracting an identifying indicator from the image of the first tag, identifying an image of a reference tag from a database using like identifying indicators between the first tag and the reference tag as comparison or matching elements, using an image processor to compare the photochromic chemical elements of the first tag with photochromic chemical elements of the reference tag, determining, using the image processor, whether the first tag contains at least one reversible photochromic chemical based on a percentage or quantity of matched photochromic chemical elements between the first tag and the reference tag, and determining, using the image processor, validity of the first tag based at least in part on the presence of the reversible photochromic chemical on the reference tag.

According to a further embodiment of the present design, there is provided a method for identifying a tag, comprising capturing, with an image capture device, a first image of the tag in which a reversible photochromic chemical has not substantially changed color, illuminating the tag with a light source of sufficient wavelength, intensity and/or exposure time to change the color of the reversible photochromic chemical, capturing a second image of the tag in which the reversible photochromic chemical has substantially changed color, comparing the first image of the tag with the second image of the tag using an imaging processor, analyzing, using the image processor, elements in the first image of the tag with respect to elements in the second image of the tag, determining, using the image processor, whether the tag contains at least one reversible photochromic chemical based on a percentage or number of matched, dissimilarly-colored photochromic chemical elements in the first image and the second image, and determining, with the image processor, identity of the tag based at least in part on the percentage or number of matched, dissimilarly-colored photochromic chemical elements in the first image versus the second image.

According to another embodiment of the present design, there is provided a method of identifying a tag with at least one unique element having a three-dimensional protrusion or 3D bump protruding above or normal to the surface of the tag, comprising sensing a tactile sensation and/or visual cue from at least one of the three-dimensional protrusions or 3D bumps, in which at least one of the three-dimensional protrusions or 3D bumps protrudes at least 0.2 millimeters above or normal to a surface of the tag, and comparing the tactile sensation and/or visual cue sensed to a reference tag to determine validity of the tag.

While the present design has been particularly shown and described with reference to some aspects or embodiments, it will be understood by those skilled in the art that various changes in form and detail may be made therein without departing from the spirit and scope of the invention.

It will be appreciated that variations of the above disclosed and other features and functions, or alternatives thereof, can be desirably combined into many other different systems or applications. Also, it will be appreciated that various presently unforeseen or unanticipated alternatives, modifications, variations or improvements therein can be subsequently made by those skilled in the art, which are also intended to be encompassed by the present design. The foregoing description of specific aspects or embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed aspects or embodiments. The phraseology or terminology employed herein is for the purpose of description and not of limitation.

What is claimed is:

1. A method for identifying a first tag, comprising:
capturing, with an image capture device, an image of the first tag;
extracting an indicator from the image of the first tag;
extracting an image or template of an image of a reference tag from a database using like serial numbers as a matching element;
employing an image processing component to match, compare, and analyze individual unique elements present on the first tag and the reference tag; and
determining, with the image processor, acceptability of the first tag based at least in part on a minimum percentage or number of matched unique elements.

2. The method of claim 1, further comprising:
extracting at least one unique element from the image of the first tag;
measuring, with an image processor, differences between at least one unique element of the first tag and at least one corresponding calibration element of the reference tag;
generating a quantity of differences between the at least one unique element and the at least one corresponding calibration element; and
assessing correspondence between the first tag and the reference tag based on the quantity of differences.

3. The method of claim 1 wherein one unique element is reflectivity.

4. The method of claim 1 wherein one unique element is color.

5. The method of claim 1 wherein one unique element is shape of at least one feature on the first tag.

6. The method of claim 1 wherein one unique element is information representing an x-y location of at least one other unique element of the first tag.

7. The method of claim 1 wherein one unique element is height or depth of a protruding 3D bump or raised textural element of the first tag raised normal to a surface of the first tag.

8. A method for identifying a first tag, comprising:
illuminating the first tag with a light source of sufficient wavelength, intensity and/or exposure time to change color of a reversible photochromic chemical on the first tag;
capturing, with an image capture device, an image of the first tag with the color of the reversible photochromic chemical having been substantially changed by the illuminating;
extracting an identifying indicator from the image of the first tag;
identifying an image of a reference tag from a database using like identifying indicators between the first tag and the reference tag as comparison or matching elements;
using an image processor to compare the photochromic chemical elements of the first tag with photochromic chemical elements of the reference tag;
determining, using the image processor, whether the first tag contains at least one reversible photochromic chemical based on a percentage or quantity of matched photochromic chemical elements between the first tag and the reference tag; and
determining, using the image processor, validity of the first tag based at least in part on the presence of the reversible photochromic chemical on the reference tag.

9. The method of claim 8 in which the light source has one or more of the following characteristics:
peak wavelength between 400 and 500 nanometers;
intensity greater than 2,000 Lux; and/or
exposure time greater than 2 seconds.

10. A method for identifying a tag, comprising:
capturing, with an image capture device, a first image of the tag in which a reversible photochromic chemical has not substantially changed color;
illuminating the tag with a light source of sufficient wavelength, intensity and/or exposure time to change the color of the reversible photochromic chemical;
capturing a second image of the tag in which the reversible photochromic chemical has substantially changed color;
comparing the first image of the tag with the second image of the tag using an imaging processor;
analyzing, using the image processor, elements in the first image of the tag with respect to elements in the second image of the tag;
determining, using the image processor, whether the tag contains at least one reversible photochromic chemical based on a percentage or number of matched, dissimilarly-colored photochromic chemical elements in the first image and the second image; and
determining, with the image processor, identity of the tag based at least in part on the percentage or number of matched, dissimilarly-colored photochromic chemical elements in the first image versus the second image.

11. The method of claim 10 in which the light source has at least one of the following characteristics:
peak wavelength between 400 and 500 nanometers;
intensity greater than 2,000 Lux; and
exposure time greater than 2 seconds.
